(19) United States
(12) Patent Application Publication
(10) Pub. No.: US 2026/0065386 A1
(43) Pub. Date: Mar. 5, 2026

(54) ENERGY INSIGHTS

(71) Applicant: Vivint LLC, Provo, UT (US)

(72) Inventors: Michael D. Childs, Provo, UT (US); Scott Burns, Provo, UT (US); JP Dowling, Provo, UT (US); Hoi Mei Wong, Provo, UT (US)

(73) Assignee: Vivint LLC, Provo, UT (US)

(21) Appl. No.: 19/316,888

(22) Filed: Sep. 2, 2025

Related U.S. Application Data
(60) Provisional application No. 63/689,257, filed on Aug. 30, 2024.

(51) Int. Cl. G06Q 50/06

(52) U.S. Cl. CPC G06Q 50/06

(57) ABSTRACT

A method is disclosed. The method includes monitoring, by a security system, a security pattern of a building based on security data corresponding to the building. The method further includes monitoring, by the security system, an energy pattern of the building based on energy information corresponding to the building. The method further includes identifying, based on the security pattern and the energy pattern, a potential reduction in the energy pattern resulting from a change in at least one of the security pattern or the energy pattern. The method further includes identifying an insight comprising an action to at least partially achieve the potential reduction in the energy pattern. The method further includes transmitting the insight to a device in communication with the security system.

### CROSS REFERENCE TO RELATED APPLICATIONS

This application claims the benefit of U.S. Provisional Patent Application No. 63/689,257 entitled “ENERGY INSIGHTS, IDEATION SESSION DISTILLATION” and filed on 30 Aug. 2024 which is incorporated herein by reference.

### FIELD

This invention relates to home automation systems and the use of a home automation system.

### BACKGROUND

Energy usage is expensive and can be difficult to understand. Automation systems allow for a user to better manage a property.

### BRIEF DESCRIPTION OF THE DRAWINGS

Specific embodiments of the invention are illustrated in the following drawings, which depict only embodiments of the invention and should not therefore to be considered to limit its scope.

FIG. 1 illustrates an example of one embodiment of a system for energy insight implementation in accordance with aspects of the present disclosure.

FIG. 2 illustrates a network map depicting a system that supports techniques for providing and implementing energy insight in accordance with aspects of the present disclosure.

FIG. 3 is a schematic block diagram illustrating one embodiment of an insight engine in accordance with aspects of the present disclosure.

FIG. 4 is a schematic block diagram illustrating one embodiment of a method for energy insight implementation in accordance with aspects of the present disclosure.

### DETAILED DESCRIPTION

Aspects of the present invention are described herein with reference to system diagrams, flowchart illustrations, and/or block diagrams of methods, apparatuses, systems, and computer program products according to embodiments of the invention. It will be understood that blocks of the flowchart illustrations and/or block diagrams, and combinations of blocks in the flowchart illustrations and/or block diagrams, can be implemented by computer readable program instruction.

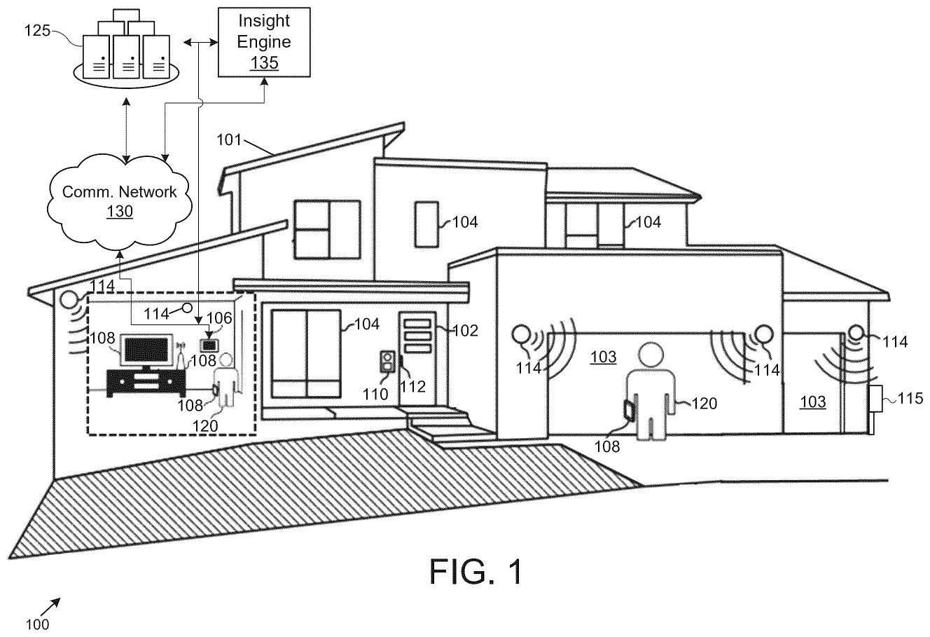

FIG. 1 depicts a diagram illustrating one example of an environment 100 in which the present systems and methods may be implemented. In some embodiments, the systems described herein may include a building automation system, which may include an interconnection of one or more controllers 106, sensors 114, computing devices 108, smart devices 108, 110, 112, and/or the like, which are described in more detail below. The environment 100 may include a building 101 such as a home, office, warehouse, garage, and/or the like. The environment 100 may include various entryways, such as doors 102, garage doors 103, and/or windows 104.

The building automation system may include any number of devices. Devices within the building automation system may be communicatively coupled to each other through a set of wired and/or wireless communication links. This communication may be accomplished, for example, via a connection to a network 130, such as a local network, the Internet, or the like. The devices may communicate with a central server or a cloud computing system. The devices may form a mesh network. When the devices are connected to a common network, the building automation system may be an Internet of Things (“IoT”) system.

The devices of the building automation system may include, for example, devices such as data collection devices, computing devices, output devices, servers, or appliances. Devices of the building automation system may operate in various sub-systems. Sub-systems of the building automation system may include, but are not limited to, security; heating, ventilation, and air conditioning (“HVAC”); lighting; electrical; fire control; and energy management systems. For example, a building automation system may include a security subsystem of devices such as cameras, entry point sensors, or smart locks. A system may additionally or alternatively include an HVAC subsystem of devices such as thermostats, temperature sensors, fans, and heaters.

In some embodiments, the environment 100 may include a structure 101 such as a building. Such a structure 101 may include a residence, a commercial or industrial building, an outdoor area, or any combination thereof. The environment 100 may include a portion of the structure 101 or the entire structure 101. Thus, the structure 101 may include devices that are not part of the building automation system. Although the environment 101 of the building automation system may include a structure 101, the building automation system may nonetheless be communicatively coupled to devices located outside of the structure 101.

The environment 100 may be divided into one or more zones. For example, a temperature setting may be employed for one room of a house that is different than that of another room of the house. In such an example, the building automation system may designate the first room as being in a particular zone to provide customized settings for that room in particular.

In some embodiments, the environment 100 may include a home, and the building automation system may be a home automation or security system (used interchangeably herein). The building automation system may include a plurality of components. These components may include, but are not limited to, devices such as controllers 106, control panels, servers, computing devices 108 (e.g., personal computers or mobile devices), displays, gateways, cameras, processors, data collection devices, automation/security devices, devices with memory, alarm devices with audio and/or visual capabilities, sensors 114, HVAC devices (e.g., thermostats, fans, heaters, or the like), electrical panels 115, appliances, interface devices, smart switches, speakers, doorbells 110, smart locks 112, and/or the like. Each of these components may be integrated with other components. For example, a camera may be integrated with a doorbell 110 to provide video footage of a person ringing the doorbell 110.

The devices may be intelligent, multi-sensing, network-connected devices that can integrate with each other and/or with a central server of a cloud-computing system in communication with the building automation system. The building automation system may provide automatic, centralized control of these devices. As such, the building automation system may provide automatic, centralized control of the building's sub-systems, such as the security, HVAC, building management, electrical, or lighting systems.

One or more devices of the building automation system may include data collection or user input capabilities. In some embodiments, these devices may be implemented to determine different behaviors of a user 120 within or immediately outside of the environment. These devices may include, but are not limited to, sensors 114, cameras, tracking devices, feedback mechanisms, interfaces, switches, and microphones.

The building automation system may also include several devices capable of both collecting and outputting data through user interfaces. These interfaces may be accessed by the user 120 through an application configured for access through the web, a mobile device, and/or a tablet. A user 120 may also access them via a terminal or control panel mounted to a wall within the home or to a piece of furniture. A control panel may interface with a network through a first set of wired and/or wireless communication links.

Such interface devices may include, for example, one or more thermostats or interfaces placed at entryways. For example, entryway interfaces may include “smart doorbells” equipped with a sensor such as a camera, touch, or motion sensor. Entryway interfaces may detect a person's entry into or departure from the premises.

The building automation system may include other data collection devices such as devices that measure usage. For example, such devices may include those that measure energy usage, water consumption, or energy generation, for example, the electrical meter/electrical panel 115.

In some embodiments, the building automation system may be a home security system. In such an embodiment, the building automation system may prevent, detect, deter, or mitigate the costs/impact of energy use, intrusions, crimes, natural disasters, or accidents occurring within the environment 100. The building automation system may carry out these functions in accordance with predetermined preferences of a user 120.

The building automation system may detect a potential intruder through one or more of its devices. The presence of a potential intruder may be communicated to one or more additional devices. The building automation system may do this by monitoring areas that are outside of the home or even outside of the environment 100. The building automation system can include interfaces that communicate such threats to a user 120. Detection devices of the building automation system may also communicate these threats to a device of the system capable of relaying the message to a user 120. For example, messages may be received by the user 120 from the building automation system through one or more mobile devices.

A building automation system embodied as a security system may include, but is not limited to, security devices such as smart locks, cameras, sensors 114, alarm devices, lighting, speakers, and garage door controls. The building automation system may provide automated, centralized control of such devices.

The building automation system may include devices with one or both of hardware and/or software components. For example, the building automation system may include a smart lock that has hardware components with the capability to lock or unlock a door and/or software components with the capability to receive instructions from a mobile device through an application, web interface, or the like.

The building automation system may include emergency response capabilities. For example, the building automation system may be connected to a cellular, radio, or computer network that serves to notify authorities and/or emergency personnel when a crime, natural disaster, or accident has occurred within the home. In some embodiments, building automation system may communicate directly with authority and/or emergency services in such an event. The building automation system may be monitored by an offsite monitoring service. The offsite monitoring service include personnel who can receive notifications of and/or monitor events taking place within the environment 100 contact emergency services when sign of such an event appear.

The building automation system may include a controller 106 that is configured to control one or more components of the building automation system. The controller 106 may be any suitable computing device. The controller 106 may include one or both of software and/or hardware components. For example, the controller 106 may include a processor, a user interface, a means of remote communication (e.g., a network interface, modem, gateway, or the like), a memory, a sensor, and/or an input/output port. The memory of the controller 106 may include instruction executable to perform various functions relating to automation and control of the building automation system. In some embodiments, the controller 106 may communicate with other components of the building automation system over a common wired or wireless connection. The controller 106 may also communicate to outside networks, such as the Internet.

The controller 106 may be part of, integrated with, and/or in communication with a control panel, an IoT or smart device (e.g., a light bulb, a light switch, a doorbell 110, a smart lock 112, or the like), a sensor 114, a computing device 108, a remote computer 125 and/or server, and/or another electronic device. In some embodiments, the controller 106 may be integrated with and/or in communication with a remote service such as a remote computer 125 and/or server. For example, the controller 106 may be located remotely to the environment 100, or the like. The controller 106 may cause components of the building automation system to perform various actions based on input received from the user 120 and/or on a certain setting. The controller 106 can cause various components of the building automation system to perform certain actions based on the occurrence of certain events. In some embodiments, the controller 106 can also receive instructions from a remote service provider. For example, if a remote service provider receives a notification that an intrusion has been detected within a home, the controller 106 may implement instructions from the remote service provider to activate various alarms within the home.

In some embodiments, the controller 106 may gather and/or analyze data from one or more devices or components associated with the environment. The controller 106 may separately, or in connection with the remote server 125, identify patterns in the security and/or energy events. For example, one or more components associated with the environment 100 may log or otherwise track security patterns corresponding to the structure 101. Security patterns may include entry and exit at the structure 101, garage door 103 actuation, occupancy of the structure 101, armed/dis-armed statuses, interior/exterior temperatures, or the like.

In some embodiments, energy patterns may also be monitored. For example, an energy pattern may include specific or general electrical consumption/generation. General electrical patterns may correspond to whole structure or general circuit electrical patterns of consumption/generation. Specific electrical patterns may include device-specific data, such as HVAC patterns, washer/dryer patterns, electrical vehicle/charger patterns, solar/wind/etc. generation patterns, pool patterns, oven patterns, hairdryer patterns, and the like. Data may be provided by separate sensors, the devices themselves, smart components (e.g., smart breaker box/electrical panel/meter/etc.), or other monitoring or measuring elements.

In some embodiments, the controller 106 may include several physical inputs. A user 120 may enter information using these inputs. Inputs may include, for example, devices such as keypads, keyboards, touch screens, buttons, switches, microphones, cameras, motion sensors, or any combination thereof. A user 120 may input data manually via, for example, a control panel, mobile computing device, desktop computing device, navigation system, gaming system, or appliance (e.g., television, HVAC, and the like). A user 120 may also input data or select controls via one or more data collection devices. For example, a user 120 may provide input via a microphone that they plan to leave the premises. The microphone can then communicate that information to the controller, which can then implement the appropriate settings based on that information. This may involve, for example, communicating with a smart lock device to lock a door. The user 120 may also provide input with instructions for the system to carry out a certain task. In that case, the controller 106 may directly influence an appropriate component of the building automation system to carry out that task. For example, if the user 120 provides an instruction to “turn the lights off,” the controller 106 can communicate those instructions to a smart light switch.

The controller 106 may also include an output display. This display may show the status of the building automation system or of various components of the building automation system. In some embodiments, the output display may be part of a graphical user interface (“GUI”) through which the building automation system may also receive inputs from the user 120. The display and/or interface of the controller 106 may provide information to the user 120.

In some embodiments, the controller 106 may communicate with one or more devices, servers, networks, or applications that are external to the building automation system. For example, the controller 106 may communicate with external devices through a cloud computing network. In some embodiments, these devices may process data received through one or more components of the building automation system. The external devices may also connect to the Internet and support an application on a mobile or computing device through which a user 120 can connect to their building automation system.

Other devices of the building automation system can also allow a user 120 to interact with the building automation system even if they are not in physical proximity to the environment 100 or any of the devices within the building automation system. For example, a user 120 may communicate with a controller 106 or another device of the building automation system using a computer (e.g., a desktop computer, laptop computer, or tablet) or a mobile device (e.g., a smartphone). A mobile or web application or web page may receive input from the user 120 and to communicate with the controller 106 to control one or more devices of the building automation system. Such a page or application may also communicate information about the device's operation to the user 120. For example, a user 120 may be able to view a mode of an alarm device of the building automation system and may change operational status of the device through the page or application.

In some embodiments, the controller 106 may be a computing device located in the environment 100. For example, the controller 106 may be a personal computer, a laptop, a desktop computer, a server, or any combination thereof.

The controller 106 can be a standalone device. For example, the controller 106 may be a smart speaker, speech synthesizer, virtual assistant device, or any combination thereof. The controller 106 may also be a control panel. The control panel may include a GUI to receive inputs from the user 120 and display information. The physical components of the control panel may be fixed to a structure within the environment 100. For example, a control panel including the controller 106 may be mounted to a wall of a home. A control panel may also be mounted to a piece of furniture. The controller 106 may also be a mobile and/or handheld device.

In certain embodiments, the controller 106 may be located remotely from the building automation system. For example, the controller 106 may control components of the building automation system from a location of a service provider. The functions of the controller 106 may include functions that involve changing a status of a component of the building automation system or causing a component of the building automation system to perform a certain action.

The controller 106 may allow a user 120 to change a status or mode of the building automation system. For example, for a building automation system that has alarm and security capabilities, the user 120 may use the controller 106 to change the status of the premises from “armed” to “disarmed” or vice versa. Other examples of statuses of the building automation system that can be affected through the controller 106 include, but are not limited to, “armed but at home,” “armed stay,” “armed and away,” “away,” “at home,” “sleeping,” “large gathering,” “nanny mode,” and/or “cleaning company here.” These statuses may reflect a user's preferences for how the building automation system should operate while that status is activated.

The user 120 may also be able to view the status of the building automation system or of one or more components of the system through a display of the controller 106. Alternatively or additionally, the controller may be able to communicate the status of the system to the user 120 through such means as audio outputs, lighting elements, messages and/or notifications transmitted to a mobile device of a user 120 (through an application, for example), or any combination thereof. The controller 106 can transmit messages or notifications to the user 120 regarding the status of one or more components of the system.

The controller 106 may allow a user 120 to control any component of the building automation system. For example, the user 120 may activate an automated vacuum, fan element, lighting element, camera, sensor, alarm, or any combination thereof through the controller 106. The user 120 may also add components to the building automation system through the controller 106. For example, if the user 120 purchases a new fan that they would like to integrate into the building automation system, they may do so by making inputs and/or selections through the controller 106.

The user 120 may also use the controller 106 to troubleshoot problems with the building automation system or components of the system. For example, if a heating element of a building automation system does not appear to be functioning properly, the user 120 may obtain a diagnosis of the problem by answering questions through the controller 106. Through the controller 106, the user 120 may provide instructions to take certain actions in response to a component of a system not functioning properly. In some embodiments, the user 120 may also communicate with one or more service providers through the controller 106. For example, the controller 106 may relay instructions to a device of the building automation system that is connected to a network to send a message to a service provider requesting a service to repair a malfunctioning component of the building automation system.

Through the controller 106, the user 120 may change or set up schedules for the building automation system. For example, the user 120 may desire that the premises be kept below a certain temperature at night and above a certain temperature during the day. Thus, the user 120 may create a schedule for the building automation system that reflects these preferences through the controller 106.

In some embodiments, the initial setup/configuration of the building automation system may be done through the controller 106. For example, when a building automation system is first implemented or installed within the premises, the user 120 may use the controller 106 to add and connect each component of the building automation system and to setup or configure their preferences. All or part of the configuration and initial setup process may be done automatically by the controller 106. For example, when a new component of the building automation system is detected, that component may be added to the building automation system automatically through the controller 106.

The controller 106 may monitor one or more components of the building automation system. The controller 106 may also track and/or store data and/or information related to the building automation system and/or operation of the sys building automation system. For example, the controller 106 may store data and/or information in a memory of the controller and/or in memory at one or more devices of the building automation system. This data/information can include, for example, user 120 preferences, weather forecasts, timestamps of entry to and departure from a structure, user 120 interactions with a component of the building automation system, settings, and other suitable data and information. The controller 106 may track and/or store this data automatically or in response to a request received from a user 120.

In one embodiment, the controller 106 may be communicatively coupled to one or more computing devices. The computing devices may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the computing devices include applications (e.g., mobile applications), programs, instructions, and/or the like for controlling one or more features of the controller 106. The computing devices, for instance, may be configured to send commands to the controller 106, to access data stored on or accessible via the controller 106, and/or the like. For example, a smart phone may be used to view photos or videos of a building via the controller 106, to view or modify temperature settings via the controller 106, and/or the like. In such an embodiment, the controller 106 may include an application programming interface (“API”), or other interface, for accessing various features, settings, data, components, elements, and/or the like of the controller 106, and the building automation system in general.

The building automation system, in one embodiment, includes one or more sensors 114 that are communicatively coupled to the controller 106. As used herein, sensors 114 may be devices that are used to detect or measure a physical property and record, indicate, or otherwise respond to it. Examples of sensors 114 that may be part of the building automation system may include motion sensors, temperature sensors, pressure sensors, light sensors, entry sensors such as window or door sensors that are used to detect when a window or door (or other entryway) is open or closed, carbon monoxide detectors, smoke detectors, water leak sensors, microphones and/or other audio sensors used to detect and/or differentiate sounds such as breaking glass, closing doors, music, dialogue, and/or the like, infrared sensors, cameras, and/or the like.

In one embodiment, the building automation system may include various cameras that are located indoors and/or outdoors and are communicatively coupled to the controller 106. The cameras may include digital cameras, video cameras, infrared cameras, and/or the like. The cameras may be mounted or fixed to a surface or structure such as a wall, ceiling, soffit, and/or the like. The cameras may be moveable such that the cameras are not fixed or secured to a surface or structure, but can be moved (e.g., a baby monitor camera).

In one embodiment, devices may include multiple sensors 114 or a combination of sensors 114. For example, a smart doorbell may include an integrated camera, a light sensor, and a motion sensor. The light sensor may be used to configure camera settings of the camera, e.g., for light or dark image capture, and the motion sensor may be used to activate the camera, to send a notification that a person is at the door, and/or the like in response to the detected motion. Furthermore, the doorbell may include a physical button to activate a wired or wireless chime within the building, a notification or sound from a mobile application associated with the doorbell, and/or the like.

In one embodiment, a camera, a controller 106, a local and/or remote computing device 125, a mobile device, and/or the like, may include image processing capabilities for analyzing images, videos, or the like that are captured with the cameras. The image processing capabilities may include object detection, facial recognition, gait detection, and/or the like. For example, the controller 106 may analyze or process images from a camera, e.g., a smart doorbell, to determine that a package is being delivered at the front door/porch. In other examples, the controller 106 may analyze or process images to detect a child walking within a proximity of a pool, to detect a person within a proximity of a vehicle, to detect a mail delivery person, to detect animals, and/or the like. In certain embodiments, the controller 106 may utilize artificial intelligence and machine learning image processing methods for processing and analyzing image and/or video captures.

In one embodiment, the controller 106 is connected to various IoT devices. As used herein, an IoT device may be a device that includes computing hardware to connect to a data network and communicate with other devices to exchange information. In such an embodiment, the controller 106 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In one embodiment, the controller 106 may poll, request, receive, or the like information from the IoT devices (e.g., status information, health information, power information, and/or the like) and present the information on a display on the controller 106, via a mobile application, and/or the like.

In one embodiment, the IoT devices include various lighting components includes smart light fixtures, smart light bulbs, smart switches, smart outlets, exterior lighting controllers, and/or the like. For instance, the controller 106 may be communicatively connected to one or more of the various lighting components to turn lighting devices on/off, change different settings of the lighting components (e.g., set timers, adjust brightness/dimmer settings, adjust color settings, and/or the like). In further embodiments, the various lighting settings may be configurable using a mobile applications, via the controller 106, running on a smart device.

In one embodiment, the IoT devices include one or more speakers within the building. The speakers may be stand-alone devices such as speakers that are part of a sound system, e.g., a home theatre system, a doorbell chime, a Bluetooth speaker, and/or the like. In certain embodiments, the one or more speakers may be integrated with other devices such as televisions, lighting components, camera devices (e.g., security cameras that are configured to generate an audible noise or alert), and/or the like.

In one embodiment, the various components of the building automation system, e.g., the controller 106, cameras and other devices, IoT devices, and/or the like, are communicatively connected over wired or wireless links of a communication network 130. The communication network 130, in one embodiment, includes a digital communication network that transmits digital communications. The communication network 130 may include a wireless network, such as a wireless cellular network, a local wireless network, such as a Wi-Fi network, a Bluetooth® network, a near-field communication (“NFC”) network, an ad hoc network, and/or the like. The communication network 130 may include a wide area network (“WAN”), a storage area network (“SAN”), a local area network (“LAN”) (e.g., a home network), an optical fiber network, the internet, or other digital communication network. The communication network 130 may include two or more networks. The communication network 130 may include one or more servers, routers, switches, and/or other networking equipment. The communication network 130 may also include one or more computer readable storage media, such as a hard disk drive, an optical drive, non-volatile memory, RAM, or the like.

The wireless network may be a mobile telephone network. The wireless network may also employ a Wi-Fi network based on any one of the Institute of Electrical and Electronics Engineers (“IEEE”) 802.11 standards. Alternatively, the wireless network may include a Bluetooth® connection. In addition, the wireless network may employ Radio Frequency Identification (“RFID”) communications including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In one embodiment, the wireless network may employ a ZigBee® connection based on the IEEE 802 standard. In such an embodiment, the wireless network includes a ZigBee® bridge. In one embodiment, the wireless network employs a Z-Wave® connection as designed by Sigma Designs®. Alternatively, the wireless connection may employ an ANT® and/or ANT+® connection as defined by Dynastream® Innovations Inc. of Cochrane, Canada.

In one embodiment, the building automation system is configured to provide various functions via the connections between the different components of the building automation system. In one embodiment, the building automation system may automate various routines and processes. The routines may be learned over time, e.g., based on the occupancy of user 120, the activities of user 120, and/or the like, and/or may be programmed or configured by a user 120 (e.g., via a digital automation platform such as If This Then That (“IFTTT”)).

For example, the building automation system may automate a “wake-up routine” for a user 120. The “wake-up routine” may define a process flow that includes starting a coffee maker, activating a water heater and/or turning on a bath/shower faucet, turning up the temperature in the building via a thermostat, triggering automated blinds/window coverings to open, turning on a television and setting it to a particular channel, and/or activating/deactivating/changing settings of lights. In such an embodiment, the process flow may be defined using an interface on the controller 106 and/or via a mobile application, and the controller 106 may coordinate communications, including instructions, commands, or signals, via a data network, to trigger different functions of the IoT devices that are included in the process flow.

The building automation system may also be configured to react to different triggers or signals. For example, a building automation system may include water leak detection and prevention components that include water leak sensors and/or a IoT device that is configured to shut off water at the main water line into the building (e.g., a smart valve that is connected to the water main, a device that is configured to actuate the shut-off valve at the water main, and/or the like). In such an embodiment, the controller 106 may receive a signal from a water leak detection sensor and may send a signal, command, instruction, or the like to the water main shut off valve to shut off the water into the building. In one embodiment, the water leak sensor may include multiple different contact points, e.g., at different levels, heights, or the like, to determine different severities of a water leak, e.g., to determine a depth, a leak rate, or the like.

In another example, the building automation system may include a smart irrigation controller that is configured to control one or more water valves and/or other components of an outdoor irrigation system (e.g., a home sprinkler system). The controller 106 may be communicatively connected to the smart irrigation controller over a data network to control various irrigation settings, automatically or in response to user 120 input. For example, a moisture sensor may detect that it is raining during or at the same time that the smart irrigation controller is configured to begin watering. In response to detecting the rain, the controller 106 may communicate with the smart irrigation controller to cancel the irrigation, to adjust the water output (e.g., based on the amount of rain that is detected), and/or the like. In some embodiments, the controller 106 may communicate with the smart irrigation controller to adjust the irrigation schedule, to delay the current irrigation (e.g., if the forecast indicates that the rain will stop within a period of time), and/or the like.

In one embodiment, the building automation system may be configured to perform various smart home functions, e.g., automated functions to assist a user 120 within a home. For example, an entry sensor on a front door that the controller 106 is communicatively connected to may detect that the door is opened, indicating the presence of a person within the home. In response to the front door sensor indicating the presence of a person, the controller 106 may trigger one or more lights, e.g., via a smart light switch and/or a smart light fixture/bulb, to turn on.

In another example, one or more entry sensors may indicate that doors and/or windows are opened frequently, which may cause the loss of heated or cooled air and/or may introduce particulates into the air within the home. Accordingly, in response to the indication from the one or more entry sensors, the controller 106 may change settings of the HVAC system (e.g., increase the volume of the HVAC system, change the temperature or humidity settings of the HVAC system, and/or the like), and may activate an air purifier within the home.

In another example, the controller 106 may receive a notification from a user's smart phone that the user 120 is within a predefined proximity or distance from the home, e.g., on their way home from work. Accordingly, the controller 106 may activate a predefined or learned comfort setting for the home, including setting a thermostat at a certain temperature, turning on certain lights inside the home, turning on certain lights on the exterior of the home, turning on the television, turning a water heater on, and/or the like.

In one embodiment, the building automation system may be configured to perform various security functions, e.g., automated functions to detect, monitor for, and/or deter the presence of an unauthorized person or activity. For example, a motion detection sensor may detect movement outside a home. In response to the motion detection, the controller 106 may activate one or more cameras that are within a proximity of the motion detection sensor to capture images and/or videos of the detected movement. The controller 106 may use image processing techniques to process the captured images/videos to determine if the detected movement is a person, and, if so, may try to identify the person. If the controller 106 cannot identify the person, or if the person is identified as an unauthorized person, the controller 106 may trigger various enhanced security measures to deter and/or react to the security threat.

For example, the controller 106 may communicate with one or more smart lighting devices to activate one or more interior and/or exterior lights. In another example, the controller 106 communicates with one or more speaker devices to generate a sound such as a whistle, alarm, of the like. In such an embodiment, sounds may be generated within the home to simulate occupancy of the home, e.g., sounds such as people talking, music, television sounds, water running, glass breaking, kids playing, and/or the like. Other sounds may be generated outside the home to simulate outdoor activities, e.g., sounds such as tools clanking or other garage noises, people walking outside, and/or the like.

The controller 106, in further embodiments, may send notifications, alerts, and/or other messages to designated persons/parties to indicate the potential security threat. For example, the controller 106 may send a push notification, text message, social media message, email message, voice message, and/or the like to an owner of the home, to emergency services, e.g., police department, and/or the like. In one embodiment, the controller 106 may include details associated with the potential security threat including a timestamp, images/videos of the person, the location (e.g., the address), and/or the like.

In one embodiment, the insight engine 135 is configured to detect a disaster event based on data captured using the sensors 114, determine a type of the disaster, e.g., a water leak, and perform a response action in response to the disaster event, e.g., notify a user, connect a user with a disaster response service or their insurance carrier, as described in more detail below.

In certain embodiments, the insight engine 135 may include a hardware device such as a secure hardware dongle or other hardware appliance device (e.g., a set-top box, a network appliance, or the like) that attaches to a device such as a head mounted display, a laptop computer, a server, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); or the like. A hardware appliance of the insight engine 135 may include a power interface, a wired and/or wireless network interface, a graphical interface that attaches to a display, and/or a semiconductor integrated circuit device as described below, configured to perform the functions described herein with regard to the insight engine 135.

The insight engine 135, in some embodiments, may include a semiconductor integrated circuit device (e.g., one or more chips, die, or other discrete logic hardware), or the like, such as an FPGA or other programmable logic, firmware for an FPGA or other programmable logic, microcode for execution on a microcontroller, an ASIC, a processor, a processor core, or the like. In one embodiment, the insight engine 135 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the insight engine 135.

The semiconductor integrated circuit device or other hardware appliance of the insight engine 135, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the insight engine 135 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

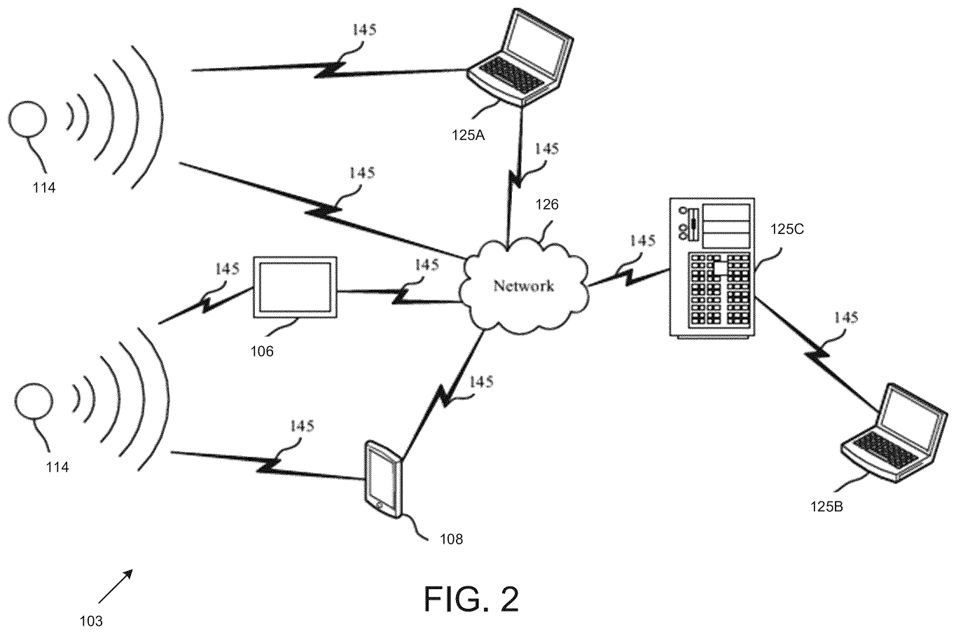

FIG. 2 illustrates a network map depicting a system that supports techniques for providing and implementing energy insight in accordance with aspects of the present disclosure. The illustrated system may be an example of a security and automation system. The system may include one or more sensors 114, one or more local computing devices 125A, control panel 106, remote computing device 125B, and server 125C. The network 126 may provide personal authentication credentials, encryption, access authorization, tracking, Internet Protocol (IP) connectivity, and other access, computation, modification, and/or functions. The control panel 108 may interface with the network 126 through a first set of wired and/or wireless communication links 145 to communicate with the server 125C. The control panel 106 may perform communication configuration, adjustment, and/or scheduling for communication with the local computing device 125A and remote computing device 125C, or may operate under the control of a controller. Control panel 106 may communicate with a back-end server (such as the server 125C)—directly and/or indirectly-using the first set of one or more wireless communication links 145. In some examples, the server 125C may be a remote server located at a location different or same from the control panel 106, the local computing device 125A, and/or the remote computing device 125B.

The control panel 106 may wirelessly communicate with the remote computing device 125B and the local computing device 125A by way of one or more antennas. The control panel 106 may provide communication coverage for a respective coverage area (e.g., residential, commercial). In some examples, the control panel 106 may be referred to as a control device, a controller, a base transceiver station, a radio base station, an access point, a radio transceiver, or some other suitable terminology. The coverage area for a control panel 106 may be divided into sectors making up only a portion of the coverage area. The security and automation system may include control panels of different types. In some examples, the security and automation system may include overlapping coverage areas for one or more different parameters, including different technologies, features, subscriber preferences, hardware, software, technology, and/or methods.

For example, one or more control panels may be related to one or more discrete structures (e.g., a house, a business) and each of the one more discrete structures may be related to one or more discrete areas (e.g., multiple houses in a neighborhood). In other examples, multiple control panels may be related to the same one or more discrete structures (e.g., multiple control panels relating to a house and/or a business complex). For example, one or more control panels may be located within a house. Additionally or alternatively, each room within the house may have a designated control panel located within each room. In some cases, the one or more control panels may communicate with one another via one or more communication protocols. In some examples, the one or more control panels may form a mesh network within the house and communicate with one another via the mesh network. In some examples, a control panel may modify or update a security parameter based on information received from one or more other control panels in the mesh network.

The local computing device 125A or remote computing device 125B may be dispersed throughout the security and automation system. In some examples, the local computing device 125A and/or remote computing device 125B may be stationary and/or mobile. In some examples, the local computing device 125A and/or remote computing device 125B may include a cellular phone, a personal digital assistant (PDA), a wireless modem, a wireless communication device, a handheld device, a tablet computer, a laptop computer, a cordless phone, a wireless local loop (WLL) station, a display device (e.g., TVs, computer monitors), a printer, a camera, and/or the like. The local computing device 125A and/or remote computing device 125B may, additionally or alternatively, include or be referred to by those skilled in the art as a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

In some examples, control panel 106 may be a smart home system panel, for example, an interactive panel mounted on a wall or other surface in a person's home. Control panel 106 may be in direct communication via wired or wireless communication links 145 with the one or more sensor units 114, or may receive sensor data from the one or more sensor units 114 via local computing device 125A and network 126, or may receive data via remote computing device 125B, server 125C, and network 126. Additionally or alternatively, the control panel 106 may wirelessly communicate with the sensor units 114 via one or more antennas. The sensor units 114 may be dispersed throughout the security and automation system and each sensor unit 114 may be stationary and/or mobile. Sensor units 114 may include and/or be one or more sensors that sense: proximity, motion, temperatures, humidity, sound level, smoke, structural features (e.g., glass breaking, window position, door position), time, light, geo-location data of a person and/or a device, distance, biometrics, weight, speed, height, size, preferences, light, darkness, weather, time, system performance, and/or other inputs that relate to a security and/or an automation system.

The local computing device 125A, remote computing device 125B, and/or a sensor units 114 may be able to communicate through one or more wired and/or wireless connections with various components such as a control panel, base stations, and/or network equipment (e.g., servers, wireless communication points) and/or the like. In some examples, one or more sensor units 114 may be located within a structure, e.g., house. Additionally or alternatively, in some examples, the structure may have a designated sensor unit located within one or more predetermined areas, e.g., rooms. In some cases, the one or more sensor units 114 may communicate with one another via one or more communication protocols. In some examples, the one or more sensor units 114 may form a mesh network within the structure and communicate with one another via the mesh network. In some examples, the mesh network associated with the sensor units 114 may be different or be a part of a mesh network associated with one or more control panels.

The wireless communication links 145 shown in the security and automation system may include uplink (UL) transmissions from a local computing device 125A to a control panel 106, and/or downlink (DL) transmissions, from a control panel 106 to the local computing device 125A. The downlink transmissions may also be called forward link transmissions while the uplink transmissions may also be called reverse link transmissions. Wireless communication links 145 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels), overhead information, user data, etc. The wireless communication links 145 may transmit bidirectional communications and/or unidirectional communications. Wireless communication links 145 may include one or more connections, including but not limited to, 345 MHz, Wi-Fi, BLUETOOTH®, BLUETOOTH® Low Energy, cellular, Z-WAVE®, 802.11, peer-to-peer, LAN, wireless local area network (WLAN), Ethernet, FireWire®, fiber optic, and/or other connection types related to security and/or automation systems.

In some examples, of the security and automation system, control panel 106, local computing device 125A, and/or remote computing device 125B may include one or more antennas for employing antenna diversity schemes to improve communication quality and reliability between control panel 106, local computing device 125A, and remote computing device 125B. Additionally or alternatively, control panel 106, local computing device 125A, and/or remote computing device 125B may employ multiple-input, multiple-output (MIMO) techniques that may take advantage of multi-path, mesh-type environments to transmit multiple spatial layers carrying the same or different coded data.

While the local computing device 125A and/or remote computing device 125B may communicate with each other through the control panel 106 using wireless communication links 145, the local computing device 125A and/or remote computing device 125B may also communicate directly with one or more other devices via one or more direct communication links (not shown). Examples of direct communication links may include Wi-Fi Direct, BLUETOOTH®, wired, and/or, and other P2P group connections. The control panel 106, local computing device 125A, and/or remote computing device 125B in these examples may communicate according to the WLAN radio and baseband protocol including physical and medium access control (MAC) layers from Institute of Electrical and Electronics Engineers (IEEE) 802.11, and its various versions including, but not limited to, 802.11b, 802.11g, 802.11a, 802.11n, 802.11ac, 802.11ad, 802.11ah, etc. In other implementations, other peer-to-peer (P2P) connections and/or ad hoc networks may be implemented within security and automation system.

In an example, local computing device 125A and remote computing device 125B may be custom computing entities configured to interact with sensor units 114 via network 126, and in some examples, via server 125C. In other examples, local computing device 125A and remote computing device 125B may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules. The local computing device 125A may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some examples, the local computing device 125A may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 114.

The processor of the local computing device 125A may be operable to control operation of the output of the local computing device 125A. The output may be a television, a liquid crystal display (LCD) monitor, a cathode ray tube (CRT) monitor, speaker, tactile output device, and/or the like. In some examples, the output may be an integral component of the local computing device 125A. Similarly, the output may be directly coupled with the processor. For example, the output may be the integral display of a tablet and/or smart phone. In some examples, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing device 125A to the output.

The remote computing device 125B may be a computing entity operable to enable a remote person to monitor the output of the sensor units 114. The remote computing device 125B may be functionally and/or structurally similar to the local computing device 125A and may be operable to receive data streams from and/or send signals to at least one of the sensor units 114 via the network 126. The network 126 may be the Internet, an intranet, a personal area network, a local area network (LAN), a wide area network (WAN), a virtual network, a telecommunications network implemented as a wired network and/or wireless network, etc. The remote computing device 125B may receive and/or send signals over the network 126 via wireless communication links 145 and server 125C.

In some examples, the sensor units 114 may be sensors configured to conduct periodic or ongoing automatic measurements related to detecting an occurrence of an event. In some examples, the sensor units 114 may be configured to determine presence, occupancy, identity, and location based on a received request. Each sensor unit 114 may be capable of sensing multiple identification and/or location determining parameters, or alternatively, separate sensor units 114 may monitor separate identification and/or location determining parameters. For example, one sensor unit 114 may determine an identity of a person, while another sensor unit 114 (or, in some examples, the same sensor unit 114) may detect an occupancy of and/or location of the person.

In some examples, the sensor units 114 may be separate from the control panel 106 and may be positioned at various locations throughout the house or the property. In other examples, the sensor units 114 may be integrated or collocated with other house and/or building automation system components, home appliances, and/or other building fixtures. For example, a sensor unit 114 may be integrated with a doorbell or door intercom system, or may be integrated with a front entrance light fixture. In other examples, a sensor unit 114 may be integrated with a wall outlet and/or switch. In other examples, the sensor units 114 may be integrated and/or collocated with the control panel 106 itself. In some examples, each of the sensor units 114, control panel 106, and/or local computing device 125A may include a speaker unit, a microphone unit, and/or a camera unit, among other things.

In some cases, a property may be monitored by the control panel 106 and/or sensor units 114. In some examples, the control panel 106 may include sensor units 114 such that the control panel 106 may directly receive signals (e.g., motion sensed, entry/exit detected) associated with the property. Each sensor unit 114 may be capable of sensing multiple occupancy parameters, or alternatively, separate sensor units may monitor separate occupancy parameters. For example, one sensor unit may be a motion sensor, while another sensor unit may detect security parameters by monitoring vibration or audio. In some cases, sensor units 114 may additionally monitor alternate security and occupancy parameters, for example by monitoring heartbeat or breathing. In some examples, occupancy may be detected by any one of a motion sensor, audio sensor, radio frequency identification (RFID) sensor, video camera, light-break sensor, or a combination thereof. In some examples, the sensor units 114 may be separate from the control panel 106, and may be positioned at various locations, also referred to herein as zones, throughout a property. In other examples, the sensor units 114 may be integrated or collocated with other security and automation system components. For example, a sensor unit 114 may be integrated with a wall, door, window for detecting entry and/or exit of a person relative to the property. In other examples, the sensor units 114 may be integrated or collocated with the control panel 106 itself.

In some cases, the control panel 106 in communication with the sensor units 114 may receive sensor data associated with at least one sensor of a home automation system. In some examples, the control panel 106 may receive a trigger to perform a security function associated with a home automation system. In some examples, the security function may be instructions to arm or disarm a property (i.e., activate alarm parameters). After receiving the instructions, the control panel 106 may determine one or more settings associated with the security and automation system. In some examples, the security and/or automation system may be referred to as a home automation system.

In some examples, one or more sensor units 114 may be configured to monitor a zone of a premises. For example, a camera may be mounted such that the camera may capture images of a driveway, a yard, a porch, etc. The camera may include or be in communication with a motion sensor for detecting movement within the zone. According to some aspects of the present disclosure, the system and methods can be implemented to perform tasks that are responsive to the detected movement. For example, upon detecting movement, the camera may be configured to begin recording video.

A computing device (e.g., a remote computing device 125B or a local computing device 125A) may be configured to track and identify patterns in the security of a structure (e.g., structure 101). The computing device may receive or track energy patterns associated with the structure. Based on the security pattern and the energy pattern, the computing device may identify a potential reduction in the energy pattern resulting from a change in at least one of the security pattern or the energy pattern. For example, the computing device may identify occupancy information in the security pattern. The occupancy information may indicate times/days in which the home is unoccupied. Based on the energy pattern, the computing device may determine that an action to adjust the HVAC schedule may result in a potential reduction in the energy pattern.

In some embodiments, the computing device may access electric utility pricing information. The information may be accessed through public resources or through a connection with the utility or other resource provider. For example, the computing device may operation through an application programming interface (API) or other interface with a service provider to access general or specific resource pricing, schedules, usage, or the like.

In response to identification of a potential reduction in the energy pattern, the computing device may generate an insight with an action to at least partially achieve the potential reduction in the energy pattern. In some embodiments, the action may be communicated to a user or implemented automatically. For example, a change to the HVAC schedule based on the occupancy information may be presented to the user for consideration, may be presented to the user for approval, may be presented to the user with instruction on how to carry out the action, or may be implemented automatically with or without a notification being provided to the user.

In some embodiments, the user may be presented with a projected value of the potential reduction in the energy pattern. In the example of the HVAC schedule, the user may be presented with a calculated value indicative of one or more of an energy bill decrease, energy savings credit, green energy contribution, energy savings goal progress, carbon footprint reduction, HVAC lifespan increase, electrical grid load reduction, and/or other data or metrics corresponding to the action of adjusting the HVAC schedule. In some embodiments, display of the calculated value of the action may serve as an incentive to the user to implement the action.

In some embodiments, the computing device may be configured to communicate (constant or periodic) with a service provided, such as an electrical service provider, gas provider, or the like. In some embodiments, in response to determination of the completion of the offer credit/reward/etc. action, the corresponding benefit or discount may be confirmed or otherwise show as applied, credited, reimbursed, or the like.

In some embodiments, the use of incentives may create more positive change in the user's energy usage. For example, participation and implementation of new actions based on the insights provided may be trackable. In some embodiments, reports or notifications may be provided which span certain timeframes. For example, the difference an action has in an hour, day, night, week, month, year, and/or multi-year period may be shown. Streak or total impact awards, credits, reimbursements, badges, milestones, discounts, gifts, and/or other incentives, or progress towards such, shown. In some embodiments, specific events may be coordinated across a number of homes, buildings, or other structures or installations.

In some embodiments, the action may be implemented automatically, based on a permission, acceptance, or other user input, or manually. In some embodiments, automated switches on various appliances or electrical devices may be used to control a power state of a device. The action may change a state or state schedule. That schedule may be set automatically, based on approval from the user, or as set manually by the user. The schedule may provide particular times based on current and/or historical energy usage and cost parameters. For example, with reference to electric car charging, the user may elect to charge the electric car after, for example, 8 PM when energy costs may be lower. The system of the present disclosure may take this input from the user and then turn on the charger to the electric car at a predetermined time that is known to have a lower energy cost associated with charging at that time. This can be done by the system of the present disclosure activating electrical relay that provides power to the charging device for the electrical car. In some embodiments, the control may serve as a relay to control one or more components of the system of the present disclosure to turn the one or more components on and/or off during selected or calculated time periods that provide cost savings.

In some embodiments, an occupancy of a structure or other property may be determined and used to identify an insight to at least partially achieve a potential reduction in the energy pattern of an environment. For example, occupancy data (current or historical) may be considered in identifying an action to reduce an energy pattern. For example, a security system may observe over time that a home is unoccupied Monday through Friday from 8 AM until 3 PM during summer months. The system may provide an insight to a user that the temperature of the home may be increased during this time to reduce energy costs. Identifying that the house typically is occupied again at 3 PM, the system may provide an insight that the HVAC system start cooling the house prior to 3 PM so that, when the occupants arrives, the house has returned to a normal and comfortable temperature. Further calculations as to when to start the cooling system to have the home reach the desired comfortable temperature may be determined by the system based on historical data and may be updated based on performance of the new HVAC schedule over time. A notification of the potential savings and/or actual savings based on an actual or calculated difference in energy usage may be provided to the user.

In some embodiments, using a tracking system, such as Global Position Satellites (GPS), cell tower triangulation, or location determination approaches, the system may determine when an occupant should arrive at the environment. When the system determines that an occupant of the house is enroute to the environment, the system may adjust the temperature parameters of the home to return to a desired or set comfortable level. In some examples, the system may determine that each occupant associated with the environment is away from the environment based upon GPS or other location service information. In response, the system may reduce energy consumption by the HVAC system until a time, proximity, or travel threshold triggers a return to a comfort setting.

In some embodiments, determination of the insight may be based on weather data. For example, a thermostat setting may be adjusted based on a forecasted temperature and/or weather event. A user may be prompted to open windows to allow for more efficient temperature control but may be notified of a chance of rain, high pollen count, wind speed indications, or the like. In some cases, the system may not prompt a user to open windows or take other action based on a weather component even though temperatures or other indicators may suggest otherwise.

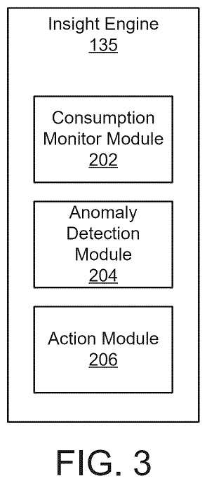

FIG. 3 depicts one embodiment of the insight engine 135 of FIG. 1. In one embodiment, the insight engine 135 includes one or more of a consumption monitor module 202, an anomaly detection module 204, and an action module 206, which are described in more detail below.

In one embodiment, the consumption monitor module 202 is configured to monitor energy consumption at a structure or other property. The consumption monitor module 202 may take in data from another collection device (e.g., a smart electrical panel, a smart switch, or the like). In some embodiments, the consumption monitor module 202 may collect energy data directly from an appliance or other device that consumes and/or generates energy or from a sensor associated with one or more devices that consume and/or generate energy. In some embodiments, the consumption monitor module 202 may provide an indication to the insight engine 135 of a change in energy pattern of a particular device or devices. In some embodiments, the consumption monitor module 202 may track historical usage data, track current data, and/or provide calculations.

The anomaly detection module 204 may be coupled to, incorporated with, or otherwise in communication with the insight engine 135. In one embodiment, the anomaly detection module 204 may detect an anomaly in power consumption and/or generation, based on data from the consumption monitor module 202, a sensor, or other sources of energy data. For instance, the anomaly detection module 204 may detect unusually high energy usage levels or may receive data directly from a sensor or appliance, and/or the like, which may be indicative of an energy anomaly. For example, power generation for a solar panel or array may be lower than expected based on historical data, weather data, and/or time of day, etc.

In another example, the anomaly detection module 204 may monitor or communicate with a ground fault indicator (GFI), circuit breaker, and/or electrical panel, etc. to identify a fault or tripped breaker. The anomaly detection module 204 may indicate this state to the insight engine 135 to identify an action for resolution. In some embodiment, the anomaly detection module 204 may be capable of determining a type of the detected anomaly based on data received and/or detected by the anomaly detection module 204. For example, the anomaly detection module 204 may analyze, process, etc. the data to determine the anomaly type. In one example, the anomaly detection module 204 may compare or cross-reference the received/detected data to stored historical or other reference data that is known to be associated with a particular anomaly type, may use machine learning or artificial intelligence to analyze the data to estimate or predict the disaster type, and/or the like.

For instance, as described above, the data relevant to the anomaly detection module 204 may include energy data, image data, video data, audio data, environmental data (e.g., moisture data, wind data, temperature data, or the like) and/or the like. The anomaly detection module 204 may analyze the data to determine that the data indicates a particular anomaly. The anomaly detection module 204 may further determine additional details associated with the detected anomaly such as the source and/or location of the anomaly, e.g., a location of an associated appliance/device/circuit/etc., a location within a structure (e.g., a bedroom, a utility room, or the like), a location of an associated sensor that captured the data associated with the anomaly, and/or the like.

In further embodiments, the consumption monitor module 202 and/or the anomaly detection module 204 may query one or more sensors (e.g., sensors 114 of FIG. 2) for sensor data to confirm the anomaly based on data captured by the one or more other sensors 114. The other sensors 114 may include sensors 114 closest or proximate to the sensors 114 that captured the data associated with the anomaly, other similar sensor types, and/or the like.

In one embodiment, the action module 206 is configured to identify and/or perform at least one action in response to the anomaly and/or the consumption. In one embodiment, the action a suggestion to change a thermostat setting to reduce energy usage. In other embodiments, the action may be an automated adjustment to the thermostat setting. The action module 206 may generate and send a notification for the consumption/anomaly in the form of an electronic notification such as a text message, an email, a push notification (e.g., to a mobile application executing on the user's device, to a control panel or smart hub associated with a home automation and/or security system, or the like), an instant message, a social media message, and/or the like. In certain embodiments, the notification may include an automated voice call (e.g., with a voice bot or with a real person), a recording, or the like.

In one embodiment, the notification may include educational diagnostic information to diagnose and remedy the consumption and/or anomaly. For instance, if the consumption/anomaly is an HVAC energy consumption, the notification may include educational materials such as surveys, flow charts, walk throughs, manuals, instructional videos, links to customer support webpages or online documentation, and/or the like to walk the user through the steps of reducing energy consumption through setting changes, filter changes/cleanings, or the like.

For instance, a text notification may include links to self-help, do-it-yourself videos, guides, walkthroughs, and/or the like for reducing energy usage. For example, the action module 206, based on an indication from at least one of the consumption monitor module 202 and/or the anomaly detection module 204, may search or reference online sources, a database of predetermined content, and/or the like to identify relevant videos or other content for helping the user to correct, fix, or otherwise remedy the energy consumption and/or lack of energy generation. The action module 206 may provide educational information as part of a follow up. For example, a day, a week, or the like after a change is made to reduce consumption or improve generation, the action module 206 may identify resources, materials, or the like, to educate the user on preventative measures to further reduce energy consumption, improve energy generation, avoid anomalies, or the like.

In one embodiment, the notification includes contact information for a repair service provider of a preferred repair network associated with a service provider such as monitoring service, installer service, maintenance service, insurance carrier, e.g., a home insurance company, or the like. For instance, the action module 206 may identify the user's energy supplier, e.g., based on the user's profile/account information associated with the structure, home automation system, or the like, and may identify one or more repair service providers that are certified or otherwise associated with the energy supplier.

In another example, the action module 206 may search or reference an insurance carrier's policy, website, a database, or the like (e.g., via an internet search, via an API, or the like) to determine an insurance carrier's preferred service provider list, to determine service providers that are within the insurance carrier's network, and/or the like. In one embodiment, the action module 206 may access a database or data store of an insurance carrier, a home automation or security provider/company (e.g., Vivint, Inc.®), and/or the like to determine the preferred service providers (e.g., based on the type of consumption and/or anomaly, based on the homeowner's insurance policy, based on the sensor data, or the like).

The action module 206 may then determine the contact information for the preferred service providers, e.g., based on information from the insurance carrier (e.g., accessible via an API, or the like), based on information queried from the Internet (e.g., from an online directory), based on information scraped from a website (e.g., a service provider's website), and/or the like. The action module 206 may automatically initiate communications or otherwise contact the service provider using the service provider information on behalf of the user, e.g., may automatically initiate a phone call, a text message, an online chat with a user or a chat bot, or the like, and transfer the communication to the user at some point during the communication. For example, the action module 206 may initiate a voice conversation with a service provide and at some point during the voice conversation, transfer the voice conversation to the user (e.g., via the user's device). In one embodiment, the action module 206 customizes the initial and subsequent messages/communications with the service provider based on a severity of the consumption/anomaly, based on the type of appliance, consumption, anomaly, and/or the like. For example, the initial communications may include an urgency message if the situation is severe whereas a less severe situation may not be as urgent.

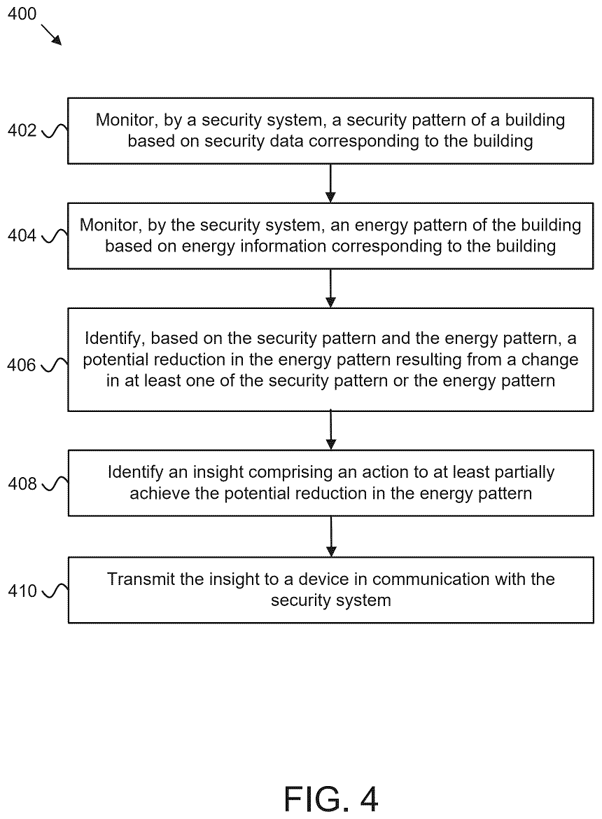

FIG. 4 depicts one embodiment of a method 400 for energy insight implementation. In one embodiment, the method 400 is performed at least in part by a controller 106, such as a smart hub or a control panel of a home automation system, by a sensor 114, by a insight engine 135, by a user's device, by a mobile application, and/or another computing device.

In some embodiments, the method 400 includes, at block 402, monitoring, by a security system, a security pattern of a building based on security data corresponding to the building. The security pattern may include an occupancy, ingress/egress day/time, an armed/disarmed pattern, a commute pattern, a number of people associated with the building, a preference of one or more persons associated with the building, and the like.

In some embodiments, the method 400 includes, at block 404, monitoring, by the security system, an energy pattern of the building based on energy information corresponding to the building. the energy pattern may include a consumption and/or generation pattern of the building, a device associated with the building, an electrical circuit associated with the building, a gas system associated with the building, a service provider of a resource associated with the building, or the like.

The method 400 may include, at block 406, identifying, based on the security pattern and the energy pattern, a potential reduction in the energy pattern resulting from a change in at least one of the security pattern or the energy pattern. In some embodiments, identification of the potential reduction includes implementing a calculation, simulation, model, or other mechanism for determining the potential reduction based on known/determined/assumed variables corresponding to one or both of the security pattern and/or energy pattern of the building. In some embodiments, the identification of the potential reduction may be based on a detected trigger. Some examples may include a user may prompt for recommendations to reduce energy usage/cost, an energy consumption reaching a certain threshold (associated or unassociated with a cost structure of a provider), a time frequency, an enrollment window for changing plans with a resource provider, or the like.

The method 400 may include, at block 408, identifying an insight comprising an action to at least partially achieve the potential reduction in the energy pattern. In some embodiments, the insight may be determined based on a look-up table, model, or other analysis or simulation associated with the building or a similar building. The potential reduction may be a projected value of a potential reduction in the energy pattern/cost/usage/etc.

The method 400 may include, at block 410, transmitting the insight to a device in communication with the security system. In some embodiments, the insight may be sent to a central hub of a system, a user's device, an email account, a text number, a phone number, or the like. The insight may be an invitation to a user to manually make a change to the security and/or energy patterns of the building, a request for permission to implement the action automatically, a notification of the action having been or planned to be implemented automatically without input from the user.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a controller 106, such as a smart hub or a control panel of a home automation system, a sensor 114, a insight engine 135, a consumption monitor module 202, an anomaly detection module 204, an action module 206, a user's device, a mobile application, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
monitoring, by a security system, a security pattern of a building based on security data corresponding to the building;
monitoring, by the security system, an energy pattern of the building based on energy information corresponding to the building;
identifying, based on the security pattern and the energy pattern, a potential reduction in the energy pattern resulting from a change in at least one of the security pattern or the energy pattern;
identifying an insight comprising an action to at least partially achieve the potential reduction in the energy pattern; and
transmitting the insight to a device in communication with the security system.

2. The method of claim 1, further comprising executing the action to at least partially achieve the potential reduction in the energy pattern.

3. The method of claim 2, wherein executing the action is performed based on a setting of the security system.

4. The method of claim 3, wherein the setting indicates executing the action is automatically performed by the security system.

5. The method of claim 3, wherein the setting indicates executing the action is in response to an input received at the device in communication with the security system.

6. The method of claim 1, wherein identifying the potential reduction further comprises calculating a projected value of the potential reduction in the energy pattern.

7. The method of claim 1, wherein transmitting the insight to the device further comprises transmitting an instruction to the device to allow a user to perform the action.

8. A system comprising:
a security device at a building to generate security data corresponding to the building;
an energy device to generate energy data corresponding to the building;
a processor; and
a memory that stores instruction executable by the processor to cause the system to:
monitor the security data from the security device to generate a security pattern;
monitor the energy data from the energy device to generate an energy pattern;
identify, based on the security pattern and the energy pattern, a potential reduction in the energy pattern resulting from a change in at least one of the security pattern or the energy pattern;
identify an insight comprising an action to at least partially achieve the potential reduction in the energy pattern; and
provide the insight to a user device associated with the security system.

9. The system of claim 8, wherein the instruction is further executable by the processor to execute the action to at least partially achieve the potential reduction in the energy pattern.

10. The system of claim 9, wherein the execution of the action is performed based on a setting of the security system.

11. The system of claim 10, wherein the setting indicates the execution of the action is automatically performed by the security system.

12. The system of claim 10, wherein the setting indicates the execution of the action is in response to input at the user device.

13. The system of claim 8, wherein the identification of the potential reduction further comprises calculation of a projected value of the potential reduction in the energy pattern.

14. The system of claim 8, wherein the provision of the insight to the user further comprises transmitting an instruction to the user device to allow a user to perform the action.

15. An apparatus comprising:
a processor;
memory in communication with the processor; and
instruction stored in the memory and executable by the processor to cause the apparatus to:
monitor a security pattern of a building based on security data corresponding to the building;
monitor an energy pattern of the building based on energy information corresponding to the building;
identify, based on the security pattern and the energy pattern, a potential reduction in the energy pattern resulting from a change in at least one of the security pattern or the energy pattern;
identify an insight comprising an action to at least partially achieve the potential reduction in the energy pattern; and
transmit the insight to a device in communication with the security system.

16. The apparatus of claim 15, wherein the instruction is further executable to perform the action to at least partially achieve the potential reduction in the energy pattern.

17. The apparatus of claim 16, wherein the performance of the action is performed based on a setting of the security system.

18. The method of claim 17, wherein the setting indicates the performance of the action is automatic.

19. The method of claim 17, wherein the setting indicates the performance of the action is in response to an input received at a device in communication with the security system.

20. The apparatus of claim 15, wherein the identification of the potential reduction further comprises a calculation of a projected value of the potential reduction in the energy pattern.
